(19) United States
(12) Patent Application Publication
(10) Pub. No.: US 2006/0282413 A1
(43) Pub. Date: Dec. 14, 2006

(54) System and method for a search engine using reading grade level analysis

(76) Inventor: Victor Joseph Bondi, Brooklyn, NY (US)

Correspondence Address: NIXON PEABODY, LLP, 401 9TH STREET, NW, SUITE 900, WASHINGTON, DC, 20004-2128, US

(21) Appl. No.: 11/265,503

(22) Filed: Nov. 3, 2005

Related U.S. Application Data
(60) Provisional application No. 60/686,923, filed on Jun. 3, 2005.

(51) Int. Cl. G06F 17/30

(52) U.S. Cl. 707/3

(57) ABSTRACT

A system and method presents search results relevant to a search query of a database based on user criteria, such as reading grade level. Reading grade level is used to rank and characterize relevant search results. The determined reading grade level of the search results provides quick and easy access to relevant documents and provides a measure of cognitive ability indicative of the content of the search page result. The system and method obtains an initial set of relevant search results from a corpus of documents in a database and determines the reading grade level of the search result documents. The system and method displays the determined reading grade level of the search results with the search results to provide an easy index or ranking.

### COPYRIGHT AUTHORIZATION

A portion of the disclosure of this document contains material that is subject to copyright protection. The copyright owner has no objection to the facsimile reproduction by anyone of the patent document or the patent disclosure, as it appears in the Patent and Trademark Office patent file or records, but otherwise reserves all copyright rights whatsoever.

### FIELD OF THE INVENTION

The present invention relates to search engines and the ranking of search results. More particularly, it relates to systems and methods for developing and using a search engine that evaluates and ranks search results based upon the reading grade level of the search results.

### BACKGROUND OF THE INVENTION

In recent years, networks and interconnectivity of individuals, groups, and organizations has taken hold. The Internet connects the world by joining billions of connected nodes (or peers) that represent various entities and information. The world wide web contains huge stores of information, allowing previously unknown resources to be accessed throughout the world. The exponential increase in communications and knowledge-gathering capabilities provided by these networks also resulted in too much communication, too much knowledge, and too many resources that result in a large quantity of information presented to the user, but with little regard for the quality of that information.

Search engines attempt to provide links to web pages or other documents in which a user may be interested. Search engines often base their determination of the user's interest on search query terms entered by the user. These search engines attempt to provide links to relevant search results based on user-entered search terms. A search engine may attempt to provide relevant results by matching the terms in the search query to a corpus of pre-stored documents. When searching the world wide web, these documents are generally embodied as web pages. Web pages that contain the user's search terms are “hits” and are returned to the user as purportedly relevant documents.

To reduce the number of irrelevant hits and to increase the quality of the document hits, search engines attempt to sort the list of hits to first present the most relevant hits to the user. The next relevant hits are shown next, and so on. To determine the relative relevancy of the individual results, the search engine may rank the result. However, determining the appropriate ranking is difficult as each individual user may be looking for a different item of interest in each of the results. The relevance of a particular web page to the user is fundamentally subjective and depends on the user's interests, knowledge, and preferences. What is essential to one user is noise to another. The relative importance of a web page may be determined by examining the contents of the web page, or by the link structure of the web page, or by other characteristics of the web page. User control of these types of determinations is paramount since the goal of a search engine is to return the most desirable pages to any user's particular search query.

What constitutes a relevant document depends not only upon the need the document may serve for a particular user, but who the particular user is as well. That is, documents may be topically relevant and understanding-level relevant. For example, on any given day, a Nobel-laureate in mathematics may wish to review recent research materials on fractals, but the next day may simply wish to show his twelve-year old child some interesting pictures of fractals. Similarly, a Nobel-laureate in mathematics may wish to review recent research materials on fractals, while a twelve-year old child may wish to obtain basic materials for a school report on fractals. That is, the relevance of a web page may be based upon the topic returned-hard core mathematics versus cool pictures in the first example—and the understanding level of the user in the second example. A topically relevant web page returns information in a context related to the query, while an understanding-level relevant web page is one written in a manner appropriate for a user with a determined level of understanding to comprehend.

Efforts to date have focused on categorizing search results as topically relevant, while determining if a web page is understanding-level relevant has been largely ignored. Understanding-level relevant web pages are often produced by a search of an editorially vetted subset of the web content that is posted to a web page service. These subsets of world wide web pages ignore millions of documents that may be directly relevant to a user or a student as they perform a search. Further, editorial oversight of these sorts of documents is costly and subjective, content is updated slowly, and subscription services are expensive. Importantly, these approaches do not make extensive use of the full and unique content on the world wide web.

What is needed is a system and a method whereby the results of a search query will provide users with the most relevant results based upon the user's level of understanding.

### SUMMARY OF THE INVENTION

The present invention relates to a system and method for presenting search results relevant to a search query based on reading grade level. The present invention provides a simple, powerful, and elegant manner in which reading grade level may be used to rank and characterize relevant search results. The determined reading grade level of the search results provides quick and easy access to relevant documents while providing a measure of cognitive ability indicative of the content of the search page result.

A preferred embodiment of the present invention determines and categorizes a user's level of understanding based upon their education or grade level. An average third-grader has less cognitive achievement than an average sixth-grader. Reading grade levels are demonstrably accurate at predicting language skills, knowledge, and other cognitive achievement. Text characteristics predict aspects of readability, and readability can be viewed as an interaction between a text and a reader's cognitive abilities. The text of a web page, and the characteristics of that text, predict aspects of readability, and may be used as an aid in determining if the web page is relevant to a particular user. If a sixth-grader conducts a search looking for information on a particular topic, it is more likely that the information categorized as conforming to a sixth-grade reading level will be more relevant to the sixth-grader's search than information categorized as being at a Nobel laureate reading level or even at a twelfth-grade reading level.

The present invention obtains an initial set of relevant search results from a corpus of documents in a database or a network of databases and determines the reading grade level of the search result documents. The invention displays the determined reading grade level of the search results with the search results to provide an easy index or ranking. The search result documents may be represented by a summary or an index of the full document as well, and a link from the search result to the full document is provided.

### BRIEF DESCRIPTION OF THE DRAWINGS

The accompanying drawings illustrate an embodiment of the invention and depict the above-mentioned and other features of this invention and the manner of attaining them. In the drawings:

FIG. 1 illustrates an exemplary computer network in accordance with an embodiment of the present invention.

FIG. 2 illustrates an exemplary search engine in accordance with the present invention.

FIGS. 3A and 3B are a flow chart illustrating methods in accordance with the present invention for presenting relevant search results.

FIG. 4 is an example of a page displaying a relevant set of documents and their associated reading grade-level.

FIG. 5 is an alternative example of a page displaying a relevant set of documents and their associated reading grade-level.

### DETAILED DESCRIPTION OF THE INVENTION

The following detailed description of the invention refers to the accompanying drawings and to certain preferred embodiments, but the detailed description of the invention does not limit the invention. The scope of the invention is defined by the appended claims and equivalents as it will be apparent to those of skill in the art that various features, variations, and modifications can be included or excluded based upon the requirements of a particular use.

The present invention extends the functionality of current search engine methods and systems used to display and rank search results by evaluating and ranking the search results based upon reading grade level. The system and method of the present invention has many advantages over prior systems because the search results are tailored to a particular user to reduce irrelevant results. The present invention may be customized for individual users to return topically relevant documents and understanding-level relevant documents. The document hits returned by the present invention significantly reduces the overall locating times and processing resources required while providing improved relevancy, consistency, and reliability in delivering pertinent documents.

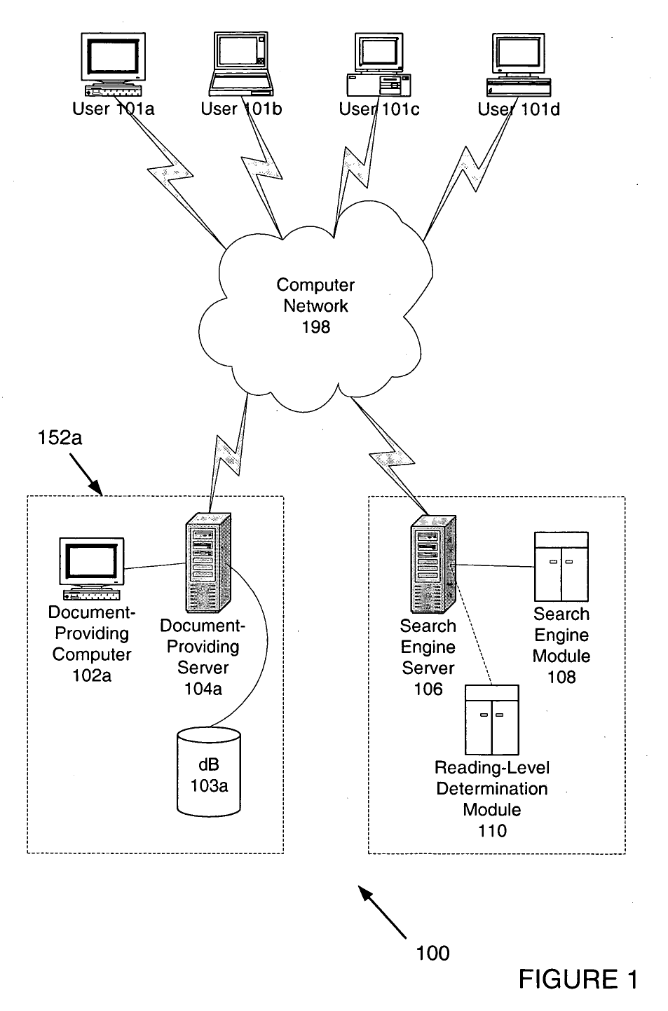

FIG. 1 illustrates an exemplary computer system in which concepts and methods consistent with the present invention may be performed.

As shown in FIG. 1, system 100 comprises a number of users 101a, 101b, 101c, 101d that may access a document collection, such as document-providing node 152a comprising a document-providing computer 102a and document-providing server 104a with which to access a database 103a of documents. For clarity and brevity, four users 101a, 101b, 101c, 101d are shown, but it should be understood that any number of users may use the system 100 with which to access documents in a database 103a. Database 103a may also be a network of databases as well. Likewise, it should also be understood that any number of document-providing nodes may be used by the system. For clarity and brevity, a single document-providing node 152a comprising a document-providing computer 102a, a document-providing server 104a, and a database 103a is shown. It should also be understood that users 101a, 101b, 101c, 101d and document-providing node 152a may be substituted for one another. That is any user 101a, 101b, 101c, 101d may access documents housed and stored by another user. Document node 152a is illustrated as components 102a, 103a, 104a merely to show a preferred embodiment and a preferred configuration. The document collection can be in a distributed environment, such as servers on the world wide web.

Users 101a, 101b, 101c, 101d may access document-providing node 152a through any computer network 198 including the Internet, telecommunications networks in any suitable form, local area networks, wide area networks, wireless communications networks, cellular communications networks, G3 communications networks, Public Switched Telephone Networks (PSTNs), Packet Data Networks (PDNs), intranets, or any combination of these networks or any group of two or more computers linked together with the ability to communicate with each other.

As illustrated in FIG. 1, computer network 198 may be the Internet where users 101a, 101b, 101c, 101d are nodes on the network as is document-providing node 152a. Users 101a, 101b, 101c, 101d and document-providing node 152a may be any suitable device capable of providing a document to another device. For example these devices may be any suitable servers, workstations, PCs, laptop computers, PDAs, Internet appliances, handheld devices, cellular telephones, wireless devices, other devices, and the like, capable of performing the processes of the exemplary embodiments of FIGS. 1-5. The devices and subsystems of the exemplary embodiments of FIGS. 1-5 can communicate with each other using any suitable protocol and can be implemented using one or more programmed computer systems or devices. In general, these devices may be any type of computing platform connected to a network and interacting with application programs.

Search engine server 106 is also a node on computer network 198. Search engine server 106 utilizes a search engine module 108. Search engine server 106 may also be any suitable device capable of using search engine module 108 to locate relevant information and documents from document-providing nodes 152a in response to search queries from users 101a, 101b, 101c, 101d.

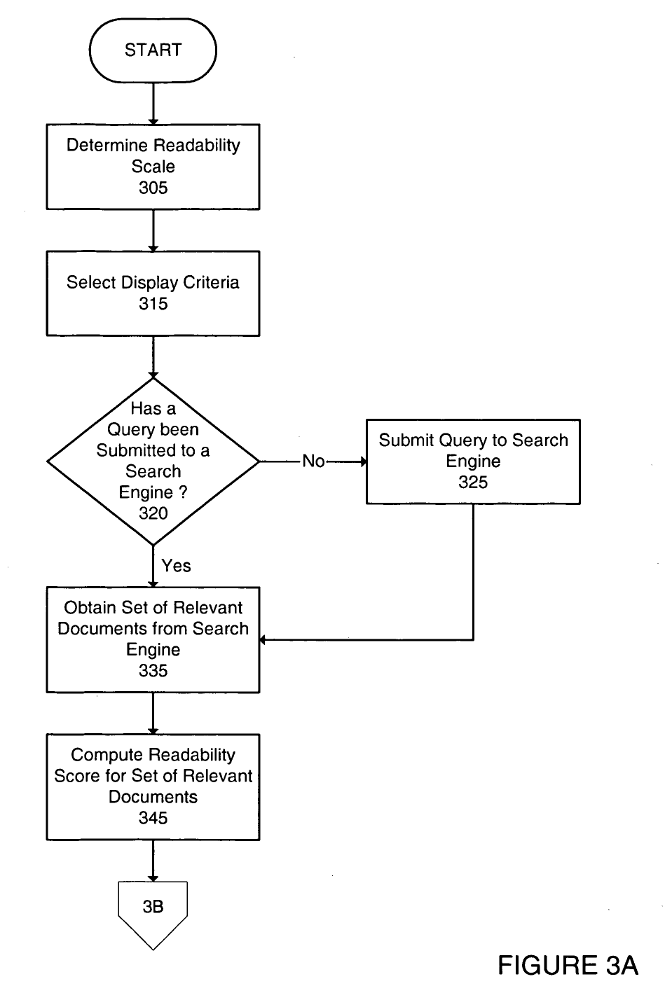

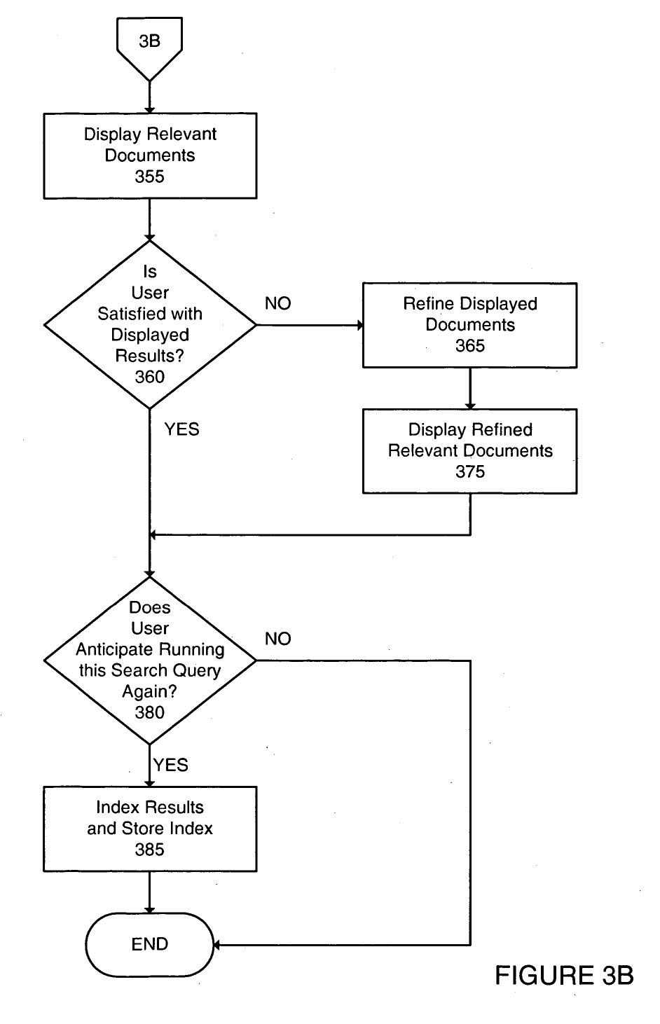

While discussed in greater detail with regard to FIG. 3, search engine module 108 locates relevant information in a known manner in response to search queries from users 101a, 101b, 101c, 101d. Users 101a, 101b, 101c, 101d send search queries to search engine server 106 via computer network 198. Search engine server 106 uses search engine module 108 to perform the query, and search engine module 108 displays a list of relevant documents to the users 101a, 101b, 101c, 101d. In a preferred embodiment, users 101a, 101b, 101c, 101d submit queries to the search engine server 106 to locate web pages relating to a particular topic or field. These web pages are normally stored at document-providing nodes 152a, other users 101a, 101b, 101c, 101d, or other devices, systems, or nodes connected to computer network 198.

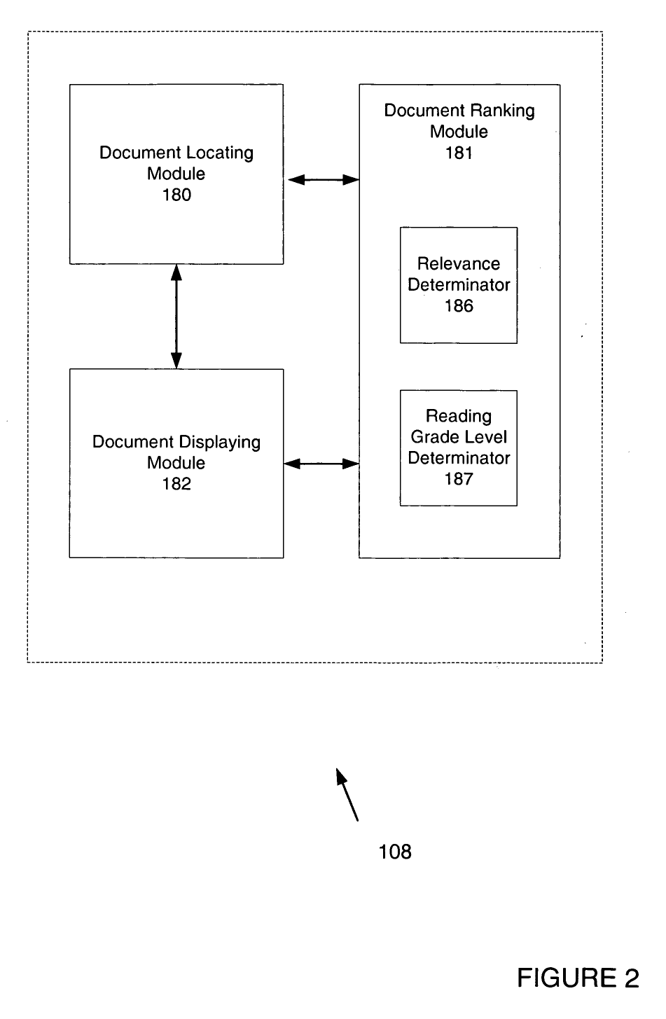

As illustrated in FIG. 2, search engine module 108 includes document locating module 180, document ranking module 181, and document displaying module 182. Document locating module 180 finds a set of documents, that is, search results, whose contents match a user search query. Document ranking module 181 ranks the located set of documents based on topical relevance using a relevance determinator 186 and further annotates the search result presentation using reading grade-level determinator 187. With this configuration, search engine module 108 is extremely flexible and responsive to a particular user's needs. For example, a variety of relevance determinators may be used in conjunction with various reading grade level determinators to rank a particular set of documents. For example, the Google™ relevance determinator may be used in conjunction with the Flesch-Kincaid reading grade level determinator to rank a particular document set. Likewise, the Google™ relevance determinator may be replaced with the Flexicon or NdustriX relevance determinators or Bayesian Inference determinators. Similarly, the Lexile Framework for Reading determinator or other reading grade level analysis programs may be substituted for the Flesch-Kincaid reading grade level determinator. Further, a user may implement their own reading grade level determinator based upon reading samples, syntactic features analysis, or semantic features analysis. Further, relevance determinator 186 is optional and may be included in the system of the present invention, or the results of a relevance analysis of topical relevance of documents from a corpus may be presented to the system with which to incorporate the method of the present invention.

Once the documents are located and the search results are annotated, document displaying module 182 may be used to present the search results to the user. For example, documents may be displayed in numerical order from the lowest reading grade level to the highest, or from the highest to the lowest. Additionally, a user may specify that the documents should be displayed in a different order, such as all documents with a sixth-grade reading level are displayed first, then documents with a fifth-grade reading level, then documents with a seventh-grade reading level. Document displaying module 182 may be used by the user to order the ranked results based upon a particular user's preference. Of course, the search results can be displayed in any order along with grade level annotations.

The devices and subsystems of the exemplary embodiments of FIGS. 1-5 are for exemplary purposes, as many variations of the specific hardware used to implement the exemplary embodiments are possible, as will be appreciated by those skilled in the relevant arts. For example, the functionality of one or more of the devices and subsystems of the exemplary embodiments of FIGS. 1-5 can be implemented via one or more programmed computer systems or devices.

To implement such variations as well as other variations, a single computer system can be programmed to perform the special purpose functions of one or more of the devices and subsystems of the exemplary embodiments of FIGS. 1-5. On the other hand, two or more programmed computer systems or devices can be substituted for any one of the devices and subsystems of the exemplary embodiments of FIGS. 1-5. Accordingly, principles and advantages of distributed processing, such as redundancy, replication, and the like, also can be implemented, as desired, to increase the robustness and performance of the devices and subsystems of the exemplary embodiments of FIGS. 1-5.

The devices and subsystems of the exemplary embodiments of FIGS. 1-5 can store information relating to various processes described herein. This information can be stored in one or more memories, such as a hard disk, optical disk, magneto-optical disk, RAM, and the like, of the devices and subsystems of the exemplary embodiments of FIGS. 1-5. One or more databases of the devices and subsystems of the exemplary embodiments of FIGS. 1-5 can store the information used to implement the exemplary embodiments of the present invention. The databases can be organized using data structures (e.g., records, tables, arrays, fields, graphs, trees, lists, and the like) included in one or more memories or storage devices listed herein. The processes described with respect to the exemplary embodiments of FIGS. 1-5 can include appropriate data structures for storing data collected and/or generated by the processes of the devices and subsystems of the exemplary embodiments of FIGS. 1-5 in one or more databases thereof.

All or a portion of the devices and subsystems of the exemplary embodiments of FIGS. 1-5 can be conveniently implemented using one or more general purpose computer systems, microprocessors, digital signal processors, micro-controllers, and the like, programmed according to the teachings of the exemplary embodiments of the present invention, as will be appreciated by those skilled in the computer and software arts. Appropriate software can be readily prepared by programmers of ordinary skill based on the teachings of the exemplary embodiments, as will be appreciated by those skilled in the software art. Further, the devices and subsystems of the exemplary embodiments of FIGS. 1-5 can be implemented on the World Wide Web. In addition, the devices and subsystems of the exemplary embodiments of FIGS. 1-5 can be implemented by the preparation of application-specific integrated circuits or by interconnecting an appropriate network of conventional component circuits, as will be appreciated by those skilled in the electrical arts. Thus, the exemplary embodiments are not limited to any specific combination of hardware circuitry and/or software.

As stated above, the devices and subsystems of the exemplary embodiments of FIGS. 1-5 can include computer readable media or memories for holding instructions programmed according to the teachings of the present invention and for holding data structures, tables, records, and/or other data described herein. Computer readable media can include any suitable medium that participates in providing instructions to a processor for execution. Such a medium can take many forms, including but not limited to, non-volatile media, volatile media, transmission media, and the like. Non-volatile media can include, for example, optical or magnetic disks, magneto-optical disks, and the like. Volatile media can include dynamic memories, and the like. Transmission media can include coaxial cables, copper wire, fiber optics, and the like. Transmission media also can take the form of acoustic, optical, electromagnetic waves, and the like, such as those generated during radio frequency (RF) communications, infrared (IR) data communications, and the like. Common forms of computer-readable media can include, for example, a floppy disk, a flexible disk, hard disk, magnetic tape, any other suitable magnetic medium, a CD-ROM, CDRW, DVD, any other suitable optical medium, punch cards, paper tape, optical mark sheets, any other suitable physical medium with patterns of holes or other optically recognizable indicia, a RAM, a PROM, an EPROM, a FLASH-EPROM, any other suitable memory chip or cartridge, a carrier wave, or any other suitable medium from which a computer can read.

The functionality of search engine modules 108 is described further below with reference to FIGS. 3A and 3B. FIGS. 3A and 3B illustrate processing steps used by a computer system 100 to present search results relevant to a search query. In step 305, a user determines a readability scale to be used to evaluate the results of a search query. The readability scale may be any of a number of accepted readability scales. For example, the Flesch-Kincaid Grade Level, Lexile Framework for Reading, McLaughlin SMOG Readability formula, Degrees of Reading Power (DRP), Woodcock Scale, Fry Readability Scale, and any number of other demonstrated-accurate readability scales may be used to evaluate the search result documents returned by a search query. Additionally, a readability scale may be preset in the method of the present invention, and user input in step 305 may be omitted.

Alternatively, users may employ their own means with which to determine the reading grade-level of a particular document. For example, a user may read a sample document and subjectively determine that the document is representative of a sixth-grade reading level. The document and the user's determination of reading grade level may then be input to the system and used to scale the returned search result documents from the search query. Similarly, a user may submit a search query to the system and subjectively evaluate one of the result documents and indicate the reading level of the document to the system. The system may then scale the other search results according to the determined scale of the evaluated result document. Users may employ syntactic features including sentence length, average number of characters per word, average number of syllables per word, percentage of various part-of-speech tags, and other readability criteria with which to base the readability of a particular document. Additionally, a user may enter a portion of text into an edit box and submit the portion to the system, and the system will evaluate the readability of the portion and return readability statistics and a resulting grade level.

In step 315, the user selects a display criteria. The display criteria is used to order the results of the search query. For example, one user may wish to have the search result documents ordered from a first-grade reading level to a twelfth-grade reading level. All documents with a first grade reading level would be listed first. Next, all documents with a second grade reading level would be listed, and so on up to the highest grade reading level. Similarly, a different user may wish to have the resulting documents ordered from highest reading grade level to lowest reading grade level.

Similarly, a user may enter a grade level in a fly-down menu, and the displayed results may be displayed with the entered grade level results first, followed by grade level results close to the entered grade level. For example, a sixth-grade user may desire to have documents with a sixth-grade reading level displayed first and then documents within ±3 grade levels displayed next.

Further, a user may wish to display the search results ordered according to the topical relevance of the search results. The most topically relevant result would be listed first along with its corresponding grade reading level. The next most topically relevant result would be listed next with its corresponding grade reading level, and so on down to the least topically relevant result and its associated reading level. In this fashion, topical relevance would be most relevant regardless of the particular grade reading level, yet the grade reading level of the individual results would be displayed along with the result. The topical relevance of the individual results may be determined by the search engine performing the query or by other similar application programs used to topically order a set of results. Additionally, a combination of topical relevance and grade reading level may-be used to display the results.

Additionally, a user may specify display criteria indicating that lower relevance be attributed to documents with fewer words or lines of text, such as portals or illustrations, and the like. Similarly, a user may further specify that document result hits be displayed according to the extension of the resulting web page. For example, web pages with .org or .edu extensions may be given a higher priority and displayed before those web pages with .com or .gov extensions. By specifying the manner in which the reading grade level relevant documents are to be displayed, the system is flexible to provide relevant results quickly and to reduce the overall search time a user must dedicate to finding, locating, and viewing relevant documents. Additionally, the display criteria may be preset in the method of the present invention, and user input in step 315 may be omitted.

In step 320, if the search query was not previously submitted to a search engine, the search query is submitted in step 325. The search engine then returns a list of relevant documents as search results, and in step 335, a set of relevant documents is obtained from the search engine. For example, each of the relevant documents is captured by the search engine server 106 from the search engine cache or from the original location database. Further, step 325 can be accomplished in a known manner, such as the methodology used by the Google™ search engine, the Yahoo® search engine, MSN® Search, and the like.

In step 345, the invention computes a readability score for a set of relevant documents. The readability scores may be computed for the entire set of relevant documents at once, or for a subset of the entire set of relevant documents depending upon the requirements of a particular use. For example, if multiple pages are required to display the set of relevant documents, readability scores may be computed for each page of results as each page of results is accessed. As well, the readability scores may be computed for any subset of the relevant document set depending upon the display criteria specified by the user.

Alternatively, a readability score is computed for a set of relevant documents when the documents are spidered, that is, before the documents are selected as search results. The readability score can then be stored with the index of the relevant documents. When a search query is conducted, the readability score is used in conjunction with the reading grade level information and other relevancy measures to display the results. With this approach, results may be displayed more quickly, but additional resources in the form of time and storage space are consumed at indexing time. The first approach adds no additional overhead to the indexing process.

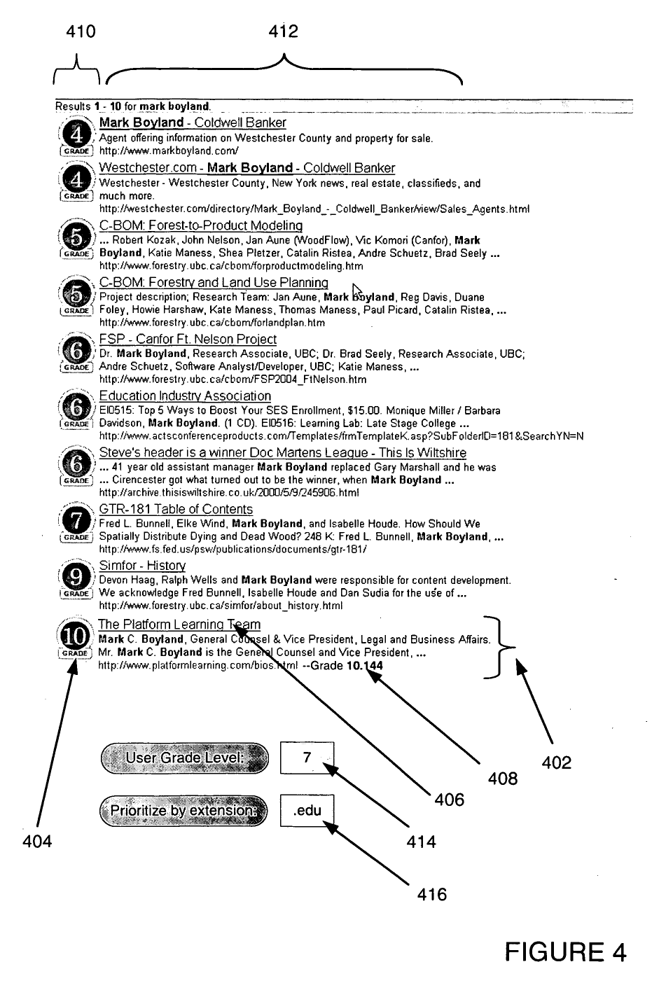

In either case, once the readability scores for the relevant documents or subset of relevant documents are computed, in step 355 the documents and their associated readability scores are displayed. For example, FIG. 4 is an example of the displayed results 402 and their associated grade level 404. Additionally, a link 406 from the individual result to the complete web page is shown. By activating the link 406, a user may go directly from the individual search result to the corresponding web page. Optionally, a link to an analysis detail used in conjunction with the readability score 408 to determine the reading grade level of the document is also provided. The example of FIG. 4 shows the results ordered by grade level, but other ordering criteria may be used as discussed above with regard to the display criteria.

If the user is not satisfied with the displayed results in step 360, in step 365 the user may reorder the displayed results using a different display criteria than was originally specified in step 315. In this manner, a user may obtain and display the most relevant documents in the manner the user deems appropriate regardless of the criteria specified prior to submitting the query to a search engine. Further, a user may reorder the displayed results by using a column sorting function, where the user selects one of the displayed columns of the displayed results screen, and the contents of the column are reordered. For example in FIG. 4, a user may select the grade level column 410 to reorder the results by descending grade levels rather than by ascending grade level as shown in FIG. 4. Alternatively, a user may select the results column 412 to reorder the display by topically relevant information rather than by grade level.

Further, a user may reorder the displayed results by changing the entered grade level in the fly-down menu 414 as shown in FIG. 4. The displayed results may be reordered depending upon additional display criteria specified by the user. For example if the sixth-grade user changed the grade level in the fly-down menu to 7, the displayed documents may be reordered so that documents within ±3 grade levels of 7 may be displayed. The entered grade level in the fly-down menu 414 may be stored in search engine server 106 so the system remembers the user's grade level between search queries or between sessions.

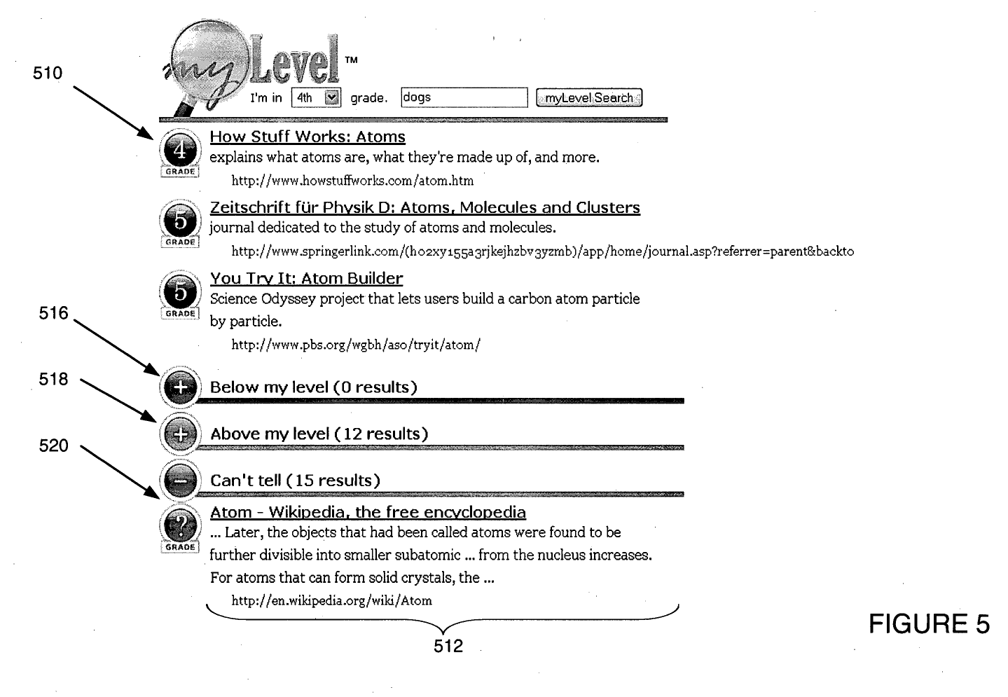

An alternative example of the displayed results is shown in FIG. 5 where the reordered results 512 are displayed by grade level 510 and an indication of results below the specified grade level 516 is shown. Likewise, an indication of the search results above the specified grade level 518 is shown as well as an indication of the search results whose grade level could not be determined 520. These indeterminate results 520 may be documents with few words such as portals, or illustrations, or the like. By refining the displayed results and providing a graphical portrait characterizing the results, a user may receive further clues as to the efficacy of the search and the manner in which the results may be characterized.

Returning to FIG. 4, the user may also refine or reprioritize the search results by extension 414 as described above, or by document characteristics, such as “more like this” or “more commercial” or “more research,” for example, or any other methods of characterizing a particular result with which other results may be compared. The refined documents are then displayed in step 375. Additionally, a user may examine a particular result and the corresponding document and make a subjective determination of the reading grade level of the result. The subjective determination may then be used to reorder the results list and scale the documents to conform to the user's determination. In this fashion, the user is customizing the search results to their particular need, based upon topical relevance as well as understanding-level relevance.

In order to further minimize the overall locating time required to find and retrieve pertinent documents, the system of the present invention may index results and store the indexed results in the search engine server 106. As shown in step 380, if a user anticipates that they will run the same search query in the future, the user can index the results and store the results in step 385. When an indexed and stored search query is then executed, the reading grade level information, results information, and display characteristics may be retrieved for those stored results, and the relevant document set may simply be updated with additional web page documents that may now be accessible. The documents previously available may be recalled from the search engine server to reduce the overall retrieval time. Once the user is satisfied with the displayed results, the process ends after step 385.

In this manner, the present invention performs a full-text search service that prioritizes and arranges search results based on the reading grade level of the returned documents and the reading ability of the user in combination with topically-relevant metrics.

The foregoing description of exemplary aspects and embodiments of the present invention provides illustration and description, but is not intended to be exhaustive or to limit the invention to the precise form disclosed. Those of skill in the art will recognize certain modifications, permutations, additions, and combinations of those embodiments are possible in light of the above teachings or may be acquired from practice of the invention. Therefore, the present invention also covers various modifications and equivalent arrangements that would fall within the purview of appended claims and claims hereafter introduced.

The claimed invention is:

1. A method of presenting search results relevant to a search query of a database, the method comprising:
obtaining an initial set of relevant search results from a corpus of documents in the database;
determining the reading grade level of the documents indicated by the initial set of relevant search results; and
displaying the determined reading grade level of at least a subset of documents indicated by the initial set of relevant search results and the corresponding at least a subset of the initial set of relevant search results.

2. The method of presenting search results of claim 1, wherein the step of determining the reading grade level of at least a subset of the documents indicated by the initial set of relevant search results is based on the Flesch-Kincaid Grade Level formula.

3. The method of presenting search results of claim 1, wherein the step of determining the reading grade level of at least a subset of the documents indicated by the initial set of relevant search results is based on the Lexile Framework for Reading.

4. The method of presenting search results of claim 1, wherein the step of determining the reading grade level of at least a subset of the documents indicated by the initial set of relevant search results is based on at least one of the McLaughlin SMOG Readability Formula, the Degrees of Reading Power (DRP) Scale, or the Fry Readability Scale.

5. The method of presenting search results of claim 1, wherein the step of determining the reading grade level of at least a subset of the documents indicated by the initial set of relevant search results is based on a user-evaluation of one of the documents.

6. The method of presenting search results of claim 1, wherein the step of determining the reading grade level of at least a subset of the documents indicated by the initial set of relevant search results is based on evaluating a sample of a reference input by the user.

7. The method of presenting search results of claim 1, wherein the step of displaying the determined reading grade level of at least a subset of documents indicated by the initial set of relevant search results and displaying the corresponding at least a subset of the initial set of relevant search results further includes a link to an analysis detail used to determine the reading grade level of the at least a subset of documents indicated by the initial set of relevant search results.

8. The method of presenting search results of claim 1, further comprising indexing the at least a subset of documents indicated by the initial set of relevant search results and the corresponding determined reading grade level of the at least a subset of documents indicated by the initial set of relevant search results to facilitate analysis and display when subsequent search queries are performed.

9. The method of presenting search results of claim 1, wherein the database comprises a network of individual databases.

10. The method of presenting search results of claim 9, further comprising presenting a query to the network of individual databases.

11. The method of presenting search results of claim 10, further comprising processing the query to obtain the initial set of search results.

12. The method of presenting search results of claim 1, further comprising ranking the at least a subset of documents indicated by the initial set of search results.

13. The method of presenting search results of claim 12, wherein the ranking of the at least a subset of documents indicated by the initial set of search results is based upon the determined reading grade level of each of the documents.

14. The method of presenting search results of claim 12, wherein the ranking of the at least a subset of documents indicated by the initial set of search results is based upon a relevance of the at least a subset of documents to the search query.

15. The method of presenting search results of claim 14, wherein the relevance of the at least a subset of documents to the search query is based upon an amount that each of the at least a subset of documents is referenced by other documents in the at least a subset of documents.

16. A data storage medium with computer-executable instructions for presenting search results relevant to a search query of a database comprising:
instructions for obtaining an initial set of relevant search results from a corpus of documents in the database;
instructions for determining the reading grade level of the documents indicated by the initial set of relevant search results; and
instructions for displaying the determined reading grade level of at least a subset of documents indicated by the initial set of relevant search results and the corresponding at least a subset of the initial set of relevant search results.

17. The data storage medium of claim 16, wherein the instructions for determining the reading grade level of at least a subset of the documents indicated by the initial set of relevant search results are based on the Flesch-Kincaid Grade Level formula.

18. The data storage medium of claim 16, wherein the instructions for determining the reading grade level of at least a subset of the documents indicated by the initial set of relevant search results are based on the Lexile Framework for Reading.

19. The data storage medium of claim 16, wherein the instructions for determining the reading grade level of at least a subset of the documents indicated by the initial set of relevant search results are based on at least one of the McLaughlin SMOG Readability Formula, the Degrees of Reading Power (DRP) Scale, or the Fry Readability Scale.

20. The data storage medium of claim 16, wherein the instructions for determining the reading grade level of at least a subset of the documents indicated by the initial set of relevant search results are based on a user-evaluation of one of the documents.

21. The data storage medium of claim 16, wherein the instructions for determining the reading grade level of at least a subset of the documents indicated by the initial set of relevant search results are based on evaluating a sample of a reference input by the user.

22. The data storage medium of claim 16, wherein the instructions for displaying the determined reading grade level of at least a subset of documents indicated by the initial set of relevant search results and displaying the corresponding at least a subset of the initial set of relevant search results further includes instructions for incorporating a link to an analysis detail used to determine the reading grade level of the at least a subset of documents indicated by the initial set of relevant search results.

23. The data storage medium of claim 16, further comprising instructions for indexing the at least a subset of documents indicated by the initial set of relevant search results and the corresponding determined reading grade level of the at least a subset of documents indicated by the initial set of relevant search results to facilitate analysis and display when subsequent search queries are performed.

24. The data storage medium of claim 16, wherein the instructions for obtaining an initial set of relevant search results from a corpus of documents in the database comprises instructions for obtaining an initial set of relevant search results from a network of individual databases.

25. The data storage medium of claim 24, further comprising instructions for presenting a query to the network of individual databases.

26. The data storage medium of claim 25, further comprising instructions for processing the query to obtain the initial set of search results.

27. The data storage medium of claim 16, further comprising instructions for ranking the at least a subset of documents indicated by the initial set of search results.

28. The data storage medium of claim 27, wherein the instructions for ranking of the at least a subset of documents indicated by the initial set of search results is based upon the determined reading grade level of each of the documents.

29. The data storage medium of claim 27, wherein the instructions for ranking of the at least a subset of documents indicated by the initial set of search results is based upon a relevance of the at least a subset of documents to the search query.

30. The data storage medium of claim 29, wherein the relevance of the at least a subset of documents to the search query is based upon an amount that each of the at least a subset of documents is referenced by other documents in the at least a subset of documents.

31. A system for presenting search results relevant to a search query of a database, the system comprising:
a document locating module for obtaining an initial set of relevant search results from a corpus of documents in the database;
a reading grade level determinator for determining the reading grade level of the documents indicated by the initial set of relevant search results; and
a document displaying module for displaying the determined reading grade level of at least a subset of documents indicated by the initial set of relevant search results and the corresponding at least a subset of the initial set of relevant search results.

32. The system for presenting search results of claim 31, wherein the reading grade level determinator for determining the reading grade level of at least a subset of the documents indicated by the initial set of relevant search results is based on at least one of the Flesch-Kincaid Grade Level formula, the Lexile Framework for Reading, the McLaughlin SMOG Readability Formula, the Degrees of Reading Power (DRP) Scale, or the Fry Readability Scale.

33. The system for presenting search results of claim 31, wherein the reading grade level determinator for determining the reading grade level of at least a subset of the documents indicated by the initial set of relevant search results is based on a user-evaluation of one of the documents.

34. The system for presenting search results of claim 31, wherein the reading grade level determinator for determining the reading grade level of at least a subset of the documents indicated by the initial set of relevant search results is based on evaluating a sample of a reference input by the user.

35. The system for presenting search results of claim 31, wherein the document displaying module for displaying the determined reading grade level of at least a subset of documents indicated by the initial set of relevant search results and displaying the corresponding at least a subset of the initial set of relevant search results further includes a link generator to navigate to an analysis detail used to determine the reading grade level of the at least a subset of documents indicated by the initial set of relevant search results.

36. The system for presenting search results of claim 31, wherein the document locating module further comprises an indexing module for indexing the at least a subset of documents indicated by the initial set of relevant search results and the corresponding determined reading grade level of the at least a subset of documents indicated by the initial set of relevant search results to facilitate analysis and display when subsequent search queries are performed.

37. The system for presenting search results of claim 31, wherein the document locating module for obtaining an initial set of relevant search results from a corpus locates documents in a network of individual databases.

38. The system for presenting search results of claim 37, wherein the document locating module further comprises a query presenter for presenting a query to the network of individual databases.

39. The system for presenting search results of claim 38, wherein the query presenter processes the query to obtain the initial set of search results.

40. The system for presenting search results of claim 39, wherein the document ranking module further comprises a relevance determinator for ranking the at least a subset of documents indicated by the initial set of search results.

41. The system for presenting search results of claim 40, wherein the document ranking module ranks the at least a subset of documents indicated by the initial set of search results based upon the determined reading grade level of each of the documents.

42. The system for presenting search results of claim 40, wherein the document ranking module ranks the at least a subset of documents indicated by the initial set of search results based upon a relevance of the at least a subset of documents to the search query.

43. The system for presenting search results of claim 42, wherein the relevance determinator determines the relevance of the at least a subset of documents to the search query based upon an amount that each of the at least a subset of documents is referenced by other documents in the at least a subset of documents.

44. A method of presenting search results relevant to a search query of a database, the method comprising:
presenting a query to a database;
processing the query to obtain documents from the database;
determining the reading grade level of the obtained documents; and
displaying the determined reading grade level of each of the obtained documents and summary search results corresponding to the obtained documents.

45. A data storage medium with computer-executable instructions for presenting search results relevant to a search query of a database comprising:
instructions for presenting a query to a database;
instructions for processing the query to obtain documents from the database;
instructions for determining the reading grade level of the obtained documents; and
instructions for displaying the determined reading grade level of each of the obtained documents and summary search results corresponding to the obtained documents.

46. A system for presenting search results relevant to a search query of a database, the system comprising:
a document locating module for presenting a query to a database and for processing the query to obtain documents from the database;
a document ranking module for determining the reading grade level of the obtained documents; and
a document displaying module for displaying the determined reading grade level of each of the obtained documents and summary search results corresponding to the obtained documents.

47. A method of presenting search results relevant to a search query of a database, the method comprising:
storing reading grade level data of a user;
obtaining an initial set of relevant documents from a corpus of documents in the database;
ranking the initial set of relevant documents to obtain a ranking score for documents in the initial set of relevant documents;
indexing the ranked initial set of relevant documents by calculating a relevance score value for documents in the ranked initial set of relevant documents, the relevance score value quantifying an amount that a document is referenced by other documents in the ranked initial set of relevant documents;
re-ordering the ranked initial set of relevant documents based upon the relevance score values; and
applying the stored reading grade level data of the user to list the re-ordered ranked initial set of relevant documents based on the applied reading grade level user data.

48. A data storage medium with computer-executable instructions for presenting search results relevant to a search query of a database comprising
instructions for storing reading grade level data of a user;
instructions for obtaining an initial set of relevant documents from a corpus of documents in the database;
instructions for ranking the initial set of relevant documents to obtain a ranking score for documents in the initial set of relevant documents;
instructions for indexing the ranked initial set of relevant documents by calculating a relevance score value for documents in the ranked initial set of relevant documents, the relevance score value quantifying an amount that a document is referenced by other documents in the ranked initial set of relevant documents;
instructions for re-ordering the ranked initial set of relevant documents based upon the relevance score values; and
instructions for applying the stored reading grade level data of the user to list the re-ordered ranked initial set of relevant documents based on the applied reading grade level user data.

49. A system for presenting search results relevant to a search query of a database, the system comprising:
a document locating module for obtaining an initial set of relevant documents from a corpus of documents in the database; and
a document ranking module including:
a reading grade level determinator for storing reading grade level data of a user and for ranking the initial set of relevant documents to obtain a ranking score for documents in the initial set of relevant documents; and further including
a relevance determinator for indexing the ranked initial set of relevant documents by calculating a relevance score value for documents in the ranked initial set of relevant documents, the relevance score value quantifying an amount that a document is referenced by other documents in the ranked initial set of relevant documents;
wherein the document ranking module re-orders the ranked initial set of relevant documents based upon the relevance score values and applies the stored reading grade level data of the user to list the re-ordered ranked initial set of relevant documents based on the applied reading grade level user data.

50. A method of presenting search results relevant to a search query of a database, the method comprising:
obtaining an initial set of relevant documents from a corpus of documents in the database;
ranking the initial set of relevant documents to obtain a ranking score for documents in the initial set of relevant documents;
applying a reading grade level determination to the ranked initial set of relevant documents to produce a grade level set of documents;
indexing the grade level set of documents by calculating a relevance score value for documents in the grade level set of documents, the relevance score value quantifying an amount that a document is referenced by other documents in the grade level set of documents; and
re-ordering the grade level set of documents based upon the relevance score values.

51. A data storage medium with computer-executable instructions for presenting search results relevant to a search query of a database comprising:
instructions for obtaining an initial set of relevant documents from a corpus of documents in the database;
instructions for ranking the initial set of relevant documents to obtain a ranking score for documents in the initial set of relevant documents;
instructions for applying a reading grade level determination to the ranked initial set of relevant documents to produce a grade level set of documents;
instructions for indexing the grade level set of documents by calculating a relevance score value for documents in the grade level set of documents, the relevance score value quantifying an amount that a document is referenced by other documents in the grade level set of documents; and
instructions for re-ordering the grade level set of documents based upon the relevance score values.

52. A system for presenting search results relevant to a search query of a database, the system comprising:
a document locating module for obtaining an initial set of relevant documents from a corpus of documents in the database;
a document ranking module including:
a relevance determinator for ranking the initial set of relevant documents to obtain a ranking score for documents in the initial set of relevant documents; and
a reading grade level determinator for applying a reading grade level determination to the ranked initial set of relevant documents to produce a grade level set of documents;
wherein the relevance determinator further indexes the grade level set of documents by calculating a relevance score value for documents in the grade level set of documents, the relevance score value quantifying an amount that a document is referenced by other documents in the grade level set of documents; and
wherein the document ranking module re-orders the grade level set of documents based upon the relevance score values.
